(19) United States
(12) Patent Application Publication
(10) Pub. No.: US 2012/0005462 A1
(43) Pub. Date: Jan. 5, 2012

(54) Hardware Assist for Optimizing Code During Processing

(75) Inventors: Ronald P. Hall, Cedar Park, TX (US); Brian R. Konigsburg, Austin, TX (US); David S. Levitan, Austin, TX (US); Brian R. Mestan, Austin, TX (US)

(73) Assignee: INTERNATIONAL BUSINESS MACHINES CORPORATION, Armonk, NY (US)

(21) Appl. No.: 12/828,697

(22) Filed: Jul. 1, 2010

(51) Int. Cl. G06F 9/38

(52) U.S. Cl. 712/239; 712/E09.045

(57) ABSTRACT

A method, data processing system, and computer program product for obtaining information about instructions. Instructions are processed. In response to processing a branch instruction in the instructions, a determination is made as to whether a result from processing the branch instruction follows a prediction of whether a branch is predicted to occur for the branch instruction. In response to the result following the prediction, the branch instruction is added to a current segment in a trace. In response to an absence of the result following the prediction, the branch instruction is added to the current segment in the trace and a first new segment and a second new segment are created. The first new segment includes a first branch instruction reached in the instructions from following the prediction. The second new segment includes a second branch instruction in the instructions reached from not following the prediction.

### BACKGROUND

1. Field

The present disclosure relates generally to an improved data processing system and, in particular, to a method and apparatus for processing instructions. Still more particularly, the present disclosure relates to a method and apparatus for identifying information about the processing of instructions for use in increasing the performance in the subsequent processing of instructions.

2. Description of the Related Art

Optimizing the processing of instructions for programs is performed at different times. For example, code may be optimized after the instructions in the code have been processed by a processor. In other cases, the program may be optimized while the instructions are being processed.

The optimization of a program may be performed by monitoring the processing of instructions for the program and changing instructions or creating new code based on the analysis. The processes used to monitor the processing instructions may include different types of performance tools. One type of performance tool is a trace tool. A trace tool uses one or more techniques to provide information about the paths through which the processing of instructions take during the running of a program. The optimization of these instructions may be placed into an instruction cache. These optimized instructions may then be used during subsequent processing.

This information also may be referred to as a trace. With this information, a process often identifies locations where time for processing instructions and/or where a location in which a higher proportion of instructions are processed during running of the program. The location of these instructions also may be referred to as “hot spots”. The identification of hot spots may be used by a process to identify changes to those instructions or other instructions to improve the performance of the program.

### SUMMARY

In one illustrative embodiment, a method is provided for obtaining information about instructions. Instructions are processed by a processor unit. In response to processing a branch instruction in the instructions, the processor unit makes a determination as to whether a result from processing the branch instruction follows a prediction of whether a branch is predicted to occur for the branch instruction. In response to the result following the prediction, the processor unit adds the branch instruction to a current segment in a trace by the processor unit. The current segment includes an identification of a set of branch instructions. Each result for each branch instruction in the current segment follows a corresponding prediction for each branch instruction. In response to an absence of the result following the prediction, the processor unit adds the branch instruction to the current segment in the trace. In response to an absence of the result following the prediction, the processor unit creates a first new segment in the trace in which the first new segment includes a first branch instruction reached in the instructions from following the prediction and a second new segment in the trace in which the second new segment includes a second branch instruction in the instructions reached from not following the prediction.

### BRIEF DESCRIPTION OF THE SEVERAL VIEWS OF THE DRAWINGS

FIG. 1 is an illustration of a data processing system in accordance with an illustrative embodiment;

FIG. 2 is a block diagram of a processor system for processing information in accordance with an illustrative embodiment;

FIG. 3 is an illustration of an instruction processing environment in accordance with an illustrative embodiment;

FIG. 4 is an illustration of a segment in accordance with an illustrative embodiment;

FIG. 5 is a diagram illustrating branch instructions in accordance with an illustrative embodiment;

FIG. 6 is an illustration of a predicted path for branch instructions in accordance with an illustrative embodiment;

FIG. 7 is an illustration of a path taken through branch instructions during processing of branch instructions in accordance with an illustrative embodiment;

FIG. 8 is an illustration of a segment generated by processing instructions in accordance with an illustrative embodiment;

FIG. 9 is an illustration of the processing of branch instructions a second time in accordance with an illustrative embodiment;

FIG. 10 is an illustration of the modification generation of segments in accordance with an illustrative embodiment;

FIG. 11 is an illustration of a high-level flowchart of a process for obtaining information about instructions processed by a processor unit in accordance with an illustrative embodiment;

FIG. 12 is an illustration of a flowchart of a process for fetching a branch instruction in accordance with an illustrative embodiment;

FIG. 13 is an illustration of a flowchart of a process for detecting whether a branch instruction has been completed in accordance with an illustrative embodiment; and

FIG. 14 is an illustration of a flowchart of a process for generating information when processing instructions in accordance with an illustrative embodiment.

### DETAILED DESCRIPTION

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device.

Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction processing system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may run entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatuses (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which run via the processor of the computer or other programmable data processing apparatus, create means for implementing the functions/acts specified in the flowchart and/or block diagram block or blocks. These computer program instructions may also be stored in a computer-readable medium that can direct a computer or other programmable data processing apparatus to function in a particular manner, such that the instructions stored in the computer-readable medium produce an article of manufacture, including instruction means, which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which run on the computer or other programmable apparatus provide processes for implementing the functions/acts specified in the flowchart and/or block diagram block or blocks.

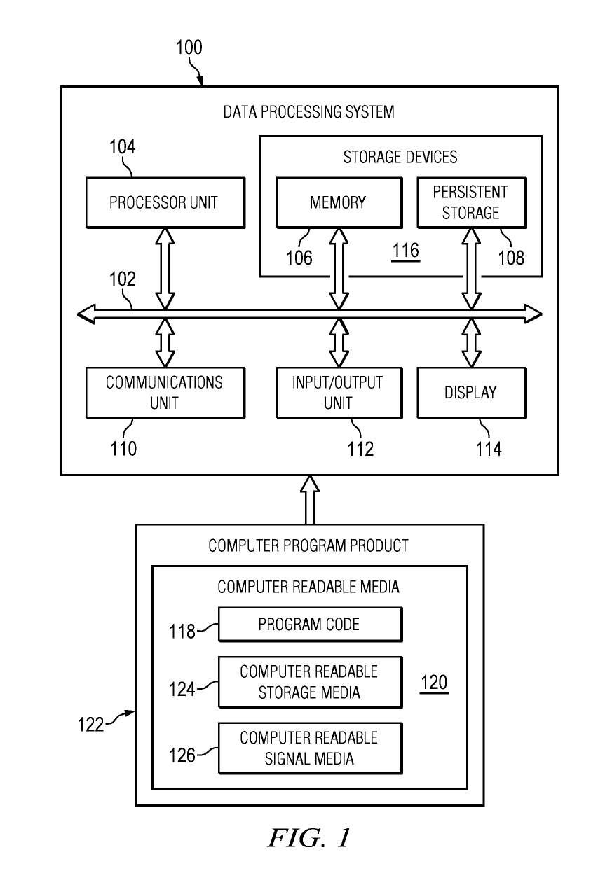

Turning now to FIG. 1, an illustration of a data processing system is depicted in accordance with an illustrative embodiment. In this illustrative example, data processing system 100 includes communications fabric 102, which provides communications between processor unit 104, memory 106, persistent storage 108, communications unit 110, input/output (I/O) unit 112, and display 114.

Processor unit 104 serves to process instructions for software that may be loaded into memory 106. Processor unit 104 may be a number of processors, a multi-processor core, or some other type of processor, depending on the particular implementation. A “number”, as used herein with reference to an item, means “one or more items”. Further, processor unit 104 may be implemented using a number of heterogeneous processor systems in which a main processor is present with secondary processors on a single chip. As another illustrative example, processor unit 104 may be a symmetric multi-processor system containing multiple processors of the same type.

Memory 106 and persistent storage 108 are examples of storage devices 116. A storage device is any piece of hardware that is capable of storing information, such as, for example, without limitation, data, program code in functional form, and/or other suitable information either on a temporary basis and/or a permanent basis. Memory 106, in these examples, may be, for example, a random access memory or any other suitable volatile or non-volatile storage device. Persistent storage 108 may take various forms, depending on the particular implementation.

For example, persistent storage 108 may contain one or more components or devices. For example, persistent storage 108 may be a hard drive, a flash memory, a rewritable optical disk, a rewritable magnetic tape, or some combination of the above. The media used by persistent storage 108 also may be removable. For example, a removable hard drive may be used for persistent storage 108.

Communications unit 110, in these examples, provides for communications with other data processing systems or devices. In these examples, communications unit 110 is a network interface card. Communications unit 110 may provide communications through the use of either or both physical and wireless communications links.

Input/output unit 112 allows for input and output of data with other devices that may be connected to data processing system 100. For example, input/output unit 112 may provide a connection for user input through a keyboard, a mouse, and/or some other suitable input device. Further, input/output unit 112 may send output to a printer. Display 114 provides a mechanism to display information to a user.

Instructions for the operating system, applications, and/or programs may be located in storage devices 116, which are in communication with processor unit 104 through communications fabric 102. In these illustrative examples, the instructions are in a functional form on persistent storage 108. These instructions may be loaded into memory 106 for processing by processor unit 104. The processes of the different embodiments may be performed by processor unit 104 using computer implemented instructions, which may be located in a memory, such as memory 106.

These instructions are referred to as program code, computer usable program code, or computer readable program code that may be read and procesed by a processor in processor unit 104. The program code in the different embodiments may be embodied on different physical or computer readable storage media, such as memory 106 or persistent storage 108.

Program code 118 is located in a functional form on computer readable media 120 that is selectively removable and may be loaded onto or transferred to data processing system 100 for processing by processor unit 104. Program code 118 and computer readable media 120 form computer program product 122 in these examples. In one example, computer readable media 120 may be computer readable storage media 124 or computer readable signal media 126. Computer readable storage media 124 may include, for example, an optical or magnetic disk that is inserted or placed into a drive or other device that is part of persistent storage 108 for transfer onto a storage device, such as a hard drive, that is part of persistent storage 108. Computer readable storage media 124 also may take the form of a persistent storage, such as a hard drive, a thumb drive, or a flash memory, that is connected to data processing system 100. In some instances, computer readable storage media 124 may not be removable from data processing system 100. In these illustrative examples, computer readable storage media 124 is a non-transitory computer readable storage medium.

Alternatively, program code 118 may be transferred to data processing system 100 using computer readable signal media 126. Computer readable signal media 126 may be, for example, a propagated data signal containing program code 118. For example, computer readable signal media 126 may be an electromagnetic signal, an optical signal, and/or any other suitable type of signal. These signals may be transmitted over communications links, such as wireless communications links, optical fiber cable, coaxial cable, a wire, and/or any other suitable type of communications link. In other words, the communications link and/or the connection may be physical or wireless in the illustrative examples.

In some illustrative embodiments, program code 118 may be downloaded over a network to persistent storage 108 from another device or data processing system through computer readable signal media 126 for use within data processing system 100. For instance, program code stored in a computer readable storage medium in a server data processing system may be downloaded over a network from the server to data processing system 100. The data processing system providing program code 118 may be a server computer, a client computer, or some other device capable of storing and transmitting program code 118.

The different components illustrated for data processing system 100 are not meant to provide architectural limitations to the manner in which different embodiments may be implemented. The different illustrative embodiments may be implemented in a data processing system including components in addition to or in place of those illustrated for data processing system 100. Other components shown in FIG. 1 can be varied from the illustrative examples shown. The different embodiments may be implemented using any hardware device or system capable of running program code. As one example, the data processing system may include organic components integrated with inorganic components and/or may be comprised entirely of organic components, excluding a human being. For example, a storage device may be comprised of an organic semiconductor.

As another example, a storage device in data processing system 100 is any hardware apparatus that may store data. Memory 106, persistent storage 108, and computer readable media 120 are examples of storage devices in a tangible form.

In another example, a bus system may be used to implement communications fabric 102 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 106, or a cache, such as found in an interface and memory controller hub that may be present in communications fabric 102.

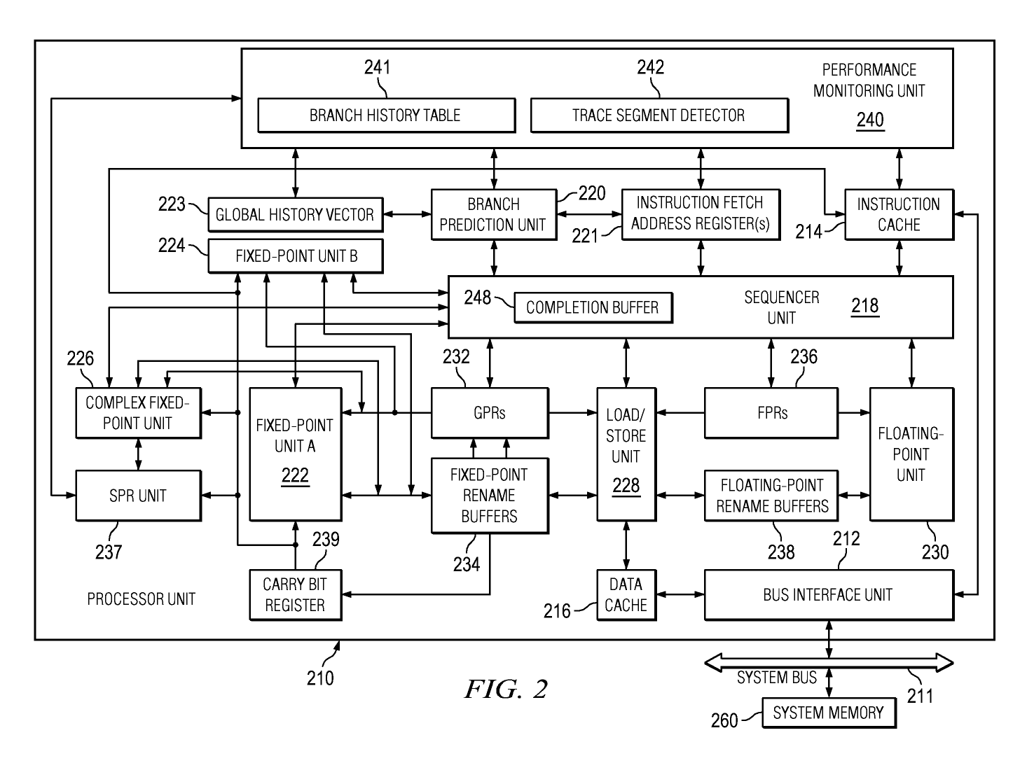

Turning next to FIG. 2, a block diagram of a processor system for processing information is depicted in accordance with an illustrative embodiment. Processor unit 210 is an example of one implementation of processor unit 104 in FIG. 1.

In an illustrative embodiment, processor unit 210 is an integrated circuit superscalar microprocessor. Processor unit 210 includes various units and different types of memory. The different types of memory may include at least one of a register, a buffer, and some other suitable type of memory. These components in processor unit 210 are implemented as integrated circuits. In addition, in the illustrative embodiment, processor unit 210 operates using reduced instruction set computer (RISC) techniques.

As used herein, the phrase “at least one of”, when used with a list of items, means that different combinations of one or more of the listed items may be used and only one of each item in the list may be needed. For example, “at least one of item A, item B, and item C” may include, for example, without limitation, item A or item A and item B. This example also may include item A, item B, and item C, or item B and item C.

System bus 211 connects to bus interface unit (BIU) 212 of processor unit 210. Bus interface unit 212 controls the transfer of information between processor unit 210 and system bus 211. Bus interface unit 212 connects to instruction cache 214 and to data cache 216 of processor unit 210. Instruction cache 214 outputs instructions to sequencer unit 218. In response to such instructions from instruction cache 214, sequencer unit 218 selectively outputs instructions to other processing circuitry of processor unit 210.

Processor unit 210 supports the processing of different types of instructions. Some instructions have a set of source operands that describe data used by the instructions. Source operands can be data or an indication of where the data is located. The data may be located in memory in processor unit 210. Additionally, some instructions have destination operands that describe where results of the instructions should be placed. Destination operands cause elements of processor unit 210 to place the result of the instruction in memory in processor unit 210.

The following example instruction has two source operands and a destination operand “fadd source operand a, source operand b, destination operand c.” In this example, fadd stands for floating-point addition operator. During processing of the example fadd instruction, elements of processor unit 210 will process the fadd instruction by adding the value from source operand a to the value from source operand b and placing the result value into destination operand c.

In addition to sequencer unit 218, processor unit 210 includes multiple units. These units include, for example, branch prediction unit 220, fixed-point unit A (FXUA) 222, fixed-point unit B (FXUB) 224, complex fixed-point unit (CFXU) 226, load/store unit (LSU) 228, and floating-point unit (FPU) 230. Fixed-point unit A 222, fixed-point unit B 224, complex fixed-point unit 226, and load/store unit 228 input their source operand information from general-purpose architectural registers (GPRs) 232 and fixed-point rename buffers (PFRs) 234.

Moreover, fixed-point unit A 222 and fixed-point unit B 224 input a “carry bit” from carry bit (CA) register 239. Fixed-point unit A 222, fixed-point unit B 224, complex fixed-point unit 226, and load/store unit 228 output results of their operations for storage at selected entries in fixed-point rename buffers 234. These results are destination operand information. In addition, complex fixed-point unit 226 inputs and outputs source operand information and destination operand information to and from special-purpose register processing (SPR) unit 237.

Floating-point unit 230 inputs its source operand information from floating-point architectural registers (FPRs) 236 and floating-point rename buffers 238. Floating-point unit 230 outputs results of its operation for storage at selected entries in floating-point rename buffers 238. In these examples, the results are destination operand information.

In response to a load instruction, load/store unit 228 inputs information from data cache 216 and copies such information to selected ones of fixed-point rename buffers 234 and floating-point rename buffer 238. If such information is not stored in data cache 216, then data cache 216 inputs through bus interface unit 212 and system bus 211 the information from system memory 260 connected to system bus 211. Moreover, data cache 216 is able to output through bus interface unit 212 and system bus 211 information from data cache 216 to system memory 260 connected to system bus 211. In response to a store instruction, load/store unit 228 inputs information from a selected one of general-purpose architectural registers (GPRs) 232 and fixed-point rename buffers 234 and copies such information to data cache 216.

Sequencer unit 218 inputs and outputs information to and from general-purpose architectural registers (GPRs) 232 and fixed-point rename buffers 234. From sequencer unit 218, branch prediction unit 220 inputs instructions and signals indicating a present state of processor unit 210. In response to such instructions and signals, branch prediction unit 220 outputs to sequencer unit 218 and instruction fetch address register(s) (IFAR) 221 signals indicating suitable memory addresses storing a sequence of instructions for processing by processor unit 210. In response to such signals from branch prediction unit 220, sequencer unit 218 fetches the indicated sequence of instructions from instruction cache 214. If one or more of the sequence of instructions is not stored in instruction cache 214, then instruction cache 214 inputs through bus interface unit 212 and system bus 211 such instructions from system memory 260 connected to system bus 211.

In response to the instructions input from instruction cache 214, sequencer unit 218 selectively dispatches the instructions to selected ones of branch prediction unit 220, fixed-point unit A 222, fixed-point unit B 224, complex fixed-point unit 226, load/store unit 228, and floating-point unit 230. Each unit processes one or more instructions of a particular class of instructions. For example, fixed-point unit A 222 and fixed-point unit B 224 perform a first class of fixed-point mathematical operations on source operands, such as addition, subtraction, ANDing, ORing and XORing. Complex fixed-point unit 226 performs a second class of fixed-point operations on source operands, such as fixed-point multiplication and division. Floating-point unit 230 performs floating-point operations on source operands, such as floating-point multiplication and division.

Information stored at a selected one of fixed-point rename buffers 234 is associated with a storage location. An example of a storage location may be, for example, one of general-purpose architectural registers (GPRs) 232 or carry bit (CA) register 239. The instruction specifies the storage location for which the selected rename buffer is allocated. Information stored at a selected one of fixed-point rename buffers 234 is copied to its associated one of general-purpose architectural registers (GPRs) 232 or carry bit register 239 in response to signals from sequencer unit 218. Sequencer unit 218 directs such copying of information stored at a selected one of fixed-point rename buffers 234 in response to “completing” the instruction that generated the information. Such copying is referred to as a “writeback.”

As information is stored at a selected one of floating-point rename buffers 238, such information is associated with one of fixed-point rename buffers 234. Information stored at a selected one of floating-point rename buffers 238 is copied to its associated one of fixed-point rename buffers 234 in response to signals from sequencer unit 218. Sequencer unit 218 directs such copying of information stored at a selected one of floating-point rename buffers 238 in response to “completing” the instruction that generated the information.

Completion buffer 248 in sequencer unit 218 tracks the completion of the multiple instructions. These instructions are instructions being processed within the units. When an instruction or a group of instructions have been completed successfully, in an sequential order specified by an application, completion buffer 248 may be utilized by sequencer unit 218 to cause the transfer of the results of those completed instructions to the associated general-purpose registers. Completion buffer 248 is located in memory in processor unit 210.

Global history vector (GHV) 223 is connected to branch prediction unit 220 and performance monitoring unit 240. Global history vector 223 stores recent paths of instruction processing by processor unit 210. Global history vector 223 is stored in memory in processor unit 210.

Branch prediction unit 220 predicts whether a branch based on the path of processing, such as, for example the history of the last few branches to have been processed.

Branch prediction unit 220 stores a bit-vector, referred to as a “global history vector”, that represents the recent path of processing. Global history vector 223 stores bits of data. Each bit of data is associated with the instructions. The position of a bit in global history vector 223 indicates how recently the associated instructions were fetched. For example, bit-0 in global history vector 223 may represent the most recent fetch and bit-n may represent n fetches ago. If the instructions fetched contained a branch instruction whose branch was taken, then a “1” may be indicated in global history vector 223 corresponding to that instruction. Otherwise, a “0” may be indicated in global history vector 223.

Upon each successive fetch of instructions, global history vector 223 is updated by shifting in appropriate “1”s and “0”s and discarding the oldest bits. The resulting data in global history vector 223 when exclusive ORed with instruction fetch address register(s) 221 selects the branch instruction in branch history table 241 that was taken or not taken as indicated by the bit in global history vector 223.

Additionally, processor unit 210 includes performance monitoring unit 240 in these illustrative examples. Performance monitoring unit 240 is an example of hardware in which different illustrative embodiments may be implemented. As depicted, performance monitoring unit 240 connects to instruction cache 214, instruction fetch address register(s) 221, branch prediction unit 220, global history vector 223, and special-purpose register processing (SPR) unit 237.

Performance monitoring unit 240 receives signals from other functional units and initiates actions. In these examples, performance monitoring unit 240 obtains information about instructions. Performance monitoring unit 240 includes branch history table 241 and trace segment detector 242.

Branch history table 241 is stored in memory in processor unit 210. Branch history table 241 stores branch predictions made by branch prediction unit 220 and trace segments created by trace segment detector 242. Further, branch history table 241 also stores information generated during the processing of instructions. For example, branch history table 241 may store addresses for each branch instruction processed.

Trace segment detector 242 identifies and stores the smallest trace segment(s) that always follow the predicted path of processing through a sequence of branch instructions. For example, without limitation, trace segment detector 242 stores the trace segment having the smallest number of branch instructions.

The different components illustrated for processor unit 210 are not meant to provide architectural limitations to the manner in which different embodiments may be implemented. The different illustrative embodiments may be implemented in a processor unit including components in addition to or in place of those illustrated for processor unit 210. Other components shown in FIG. 2 can be varied from the illustrative examples shown.

The illustrative embodiments recognize and take into account a number of different considerations. For example, the different illustrative embodiments recognize and take into account that after instructions have been compiled and are being run on a processor, it may be useful to know what branches in the running of the instructions tend to go to the same location. The different illustrative embodiments recognize and take into account that this information may be used to change the instructions to run a new set of instructions that may have been modified to increase the performance. The diversion of the processing of instructions to the new instructions may be performed by knowing where branches in the processing of instructions occur in a program.

The illustrative embodiments also recognize and take into account that employing software processes to identify these branches and processing of instructions and to change or create new code that increases the performance of the program may not occur as quickly as desired. The illustrative embodiments recognize and take into account that it would be desirable to have hardware to assist in the identification of where branches in the running of instructions may occur in a program during the processing of those instructions.

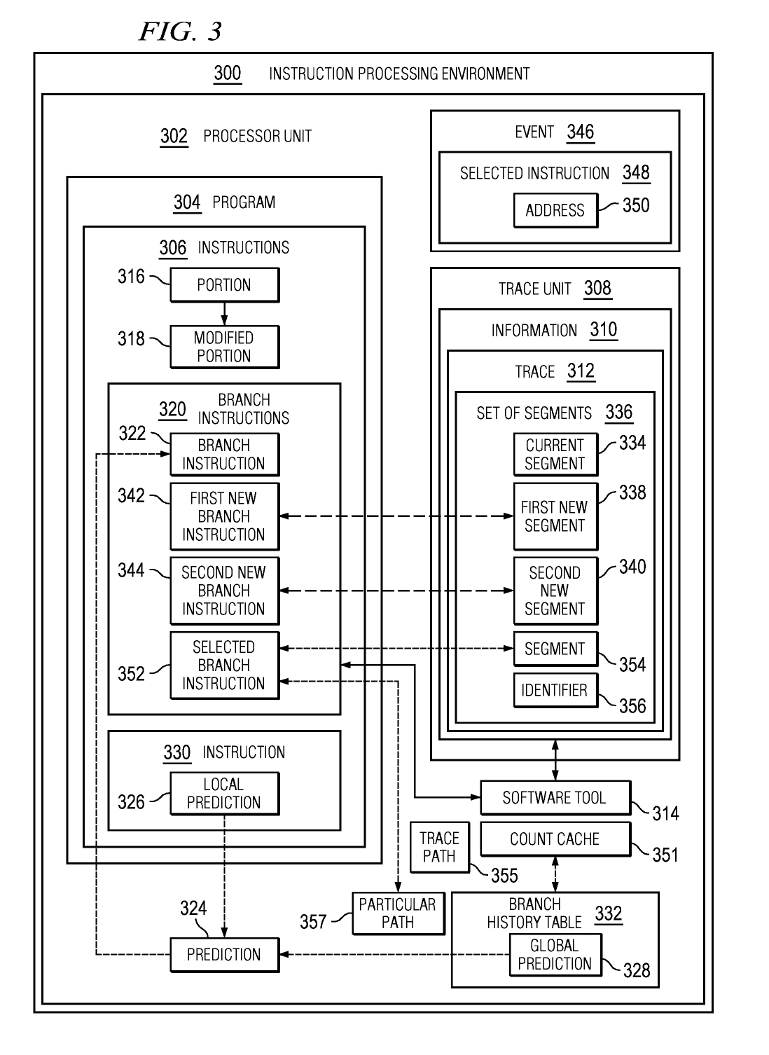

With reference now to FIG. 3, an illustration of an instruction processing environment is depicted in accordance with an illustrative embodiment. Instruction processing environment 300 in FIG. 3 may be implemented within data processing system 100 in FIG. 1. Hardware components in instruction processing environment 300 may be implemented using processor unit 104 in FIG. 1. In particular, processor unit 210 in FIG. 2 is an example of a processor in which hardware assists may be implemented in instruction processing environment 300.

In these illustrative examples, processor unit 302 may be implemented using a processor, such as processor unit 210 in FIG. 2. Processor unit 302 may run program 304, which includes instructions 306. Trace unit 308 in processor unit 302 is hardware within processor unit 302. Trace unit 308 may take the form of trace segment detector 242 in performance monitoring unit 240 in processing unit 210 in FIG. 2. In these illustrative examples, trace unit 308 generates information 310 during the processing of instructions 306 for program 304. In these examples, information 310 takes the form of trace 312.

Trace 312 may be used by software tool 314 to improve the performance of program 304. For example, software tool 314 may use trace 312 to identify portion 316 in instructions 306. Portion 316 may be modified to increase performance in program 304. Modified portion 318 may then be processed in place of portion 316 to increase the performance of program 304.

In the illustrative examples, during the processing of instructions 306, branch instructions 320 in instructions 306 are processed by processor unit 302. In these illustrative examples, a branch instruction is an instruction that may lead to one or more target instructions. If the next instruction is an instruction subsequent to the branch instruction, then the flow of processing follows a normal flow. In other words, a “branch” is not taken. A “branch” or “jump” is an alteration in the flow of processing. If the target instruction is another instruction located elsewhere other than after the branch instruction, then the flow of the processing is considered to be altered. When the flow of processing is considered to be altered, a branch has been taken.

As a result, a branch to a target instruction from a branch instruction can be taken or not taken. If the branch is not taken, the flow of processing is unaltered, and the next instruction in the instructions is processed. If the next instruction is located in another location other than after the branch instruction, then the branch from the branch instruction is considered to be taken. A branch may have two forms. A conditional branch from a branch instruction is one that can be taken or not taken. An unconditional branch is a branch which is always taken when the branch instruction is processed. An example of a branch instruction with a conditional branch is an if/then instruction. An example of an instruction with an unconditional branch is an unconditional return from a subroutine instruction.

Additionally, in these depicted examples, a branch instruction may be an indirect branch instruction or a non-indirect branch instruction. An indirect branch instruction uses an effective address of a target instruction as the address for the target instruction of the indirect branch instruction. This address may be loaded from a register. For example, for IBM Power PC®, the address is loaded from a ctr register holding the effective address of the target instruction. A non-indirect branch instruction, however, uses an offset from the effective address of the non-indirect branch instruction as the address for the target instruction of the non-indirect branch instruction. In other words, the non-indirect branch instruction may be a relative branch to the effective address of the non-indirect branch instruction plus or minus an offset that is stored into the non-indirect instruction.

Another form of a non-indirect branch instruction is an absolute address branch instruction where the target address is a sign extended field in the non-indirect branch instruction. In these examples, the reach of the non-indirect branch instruction may be limited by the length of the field in the non-indirect branch instruction that specifies the offset or the absolute address for the target instruction. In other words, a fewer number of bits may be used to store the address for the target instruction of the non-indirect branch instruction as compared to the indirect branch instruction.

In the illustrative examples, in response to processing branch instruction 322 in branch instructions 320, a determination is made by processor unit 302 as to whether a result from processing branch instruction 322 follows prediction 324 associated with branch instruction 322. In these examples, each branch instruction may be associated with a prediction. In other words, prediction 324 is the prediction for branch instruction 322. Prediction 324 is a prediction that corresponds to branch instruction 322. In the different illustrative examples, any number of existing branch prediction mechanisms may be used to identify the trace path indicated by prediction 324.

Prediction 324 may be based on at least one of local prediction 326 and global prediction 328. As used herein, the phrase “at least one of”, when used with a list of items, means that different combinations of one or more of the listed items may be used and only one of each item in the list may be needed. For example, “at least one of item A, item B, and item C” may include, for example, without limitation, item A or item A and item B. This example also may include item A, item B, and item C, or item B and item C.

In this illustrative example, local prediction 326 may be identified using a set of bits. As one illustrative example, local prediction 326 may be identified using a set of bits containing two bits. After the first time a branch instruction is processed, a value is stored in the first bit in the set of bits to indicate whether the branch indicated by the branch instruction is taken. For example, a value of “1” is stored in the first bit whether the branch is taken. Local prediction 326 then identifies that the branch will be taken during subsequent processing of the branch instruction. The value in the second bit is an indication of the strength of this local prediction. In some illustrative examples, the second bit may be optional.

After the first time the branch instruction is processed, a value of “0” is stored in the second bit. The next time the branch instruction is processed, the value in the second bit may be changed depending on whether the branch is taken. If processing of the branch instruction follows the predicted path indicated by the first bit, the value for the second bit is changed to “1”. If processing of the branch instruction does not follow the predicted path indicated by the first bit, the value for the second bit remains “0”. When the predicted path is not followed, the value for the first bit is changed.

For example, when the second bit has a value of “0”, if processing of the branch instruction follows the predicted path, the first bit is not changed but the second bit is changed from “0” to “1”. If a subsequent processing of the branch instruction again follows the predicted path, then the second bit remains “1”. However, if the subsequent processing of the branch instruction does not follow the predicted path, the first bit remains unchanged, while the second bit is changed to “0”.

As yet another example, if the second bit has a value of “0” and processing of the branch instruction does not follow the predicted path, the value for the first bit is changed either from a “0” to a “1” or from a “1” to a “0”.

In this illustrative example, local prediction 326 for a branch instruction may be stored in a buffer that may be indexed based on the effective address of the branch instruction. Local prediction 326 may have only one set of bits per branch instruction. Additionally, the local prediction may be the same for a branch instruction regardless of the path taken to reach the branch instruction.

In these examples, local prediction 326 may take the form of instruction 330 in instructions 306. In other words, instruction 330 may indicate local prediction 326. Instruction 330 may be located just prior to branch instruction 322 within instructions 306. The placement of instruction 330 prior to branch instruction 322 is an example of the manner in which local prediction 326 in instruction 330 is associated with branch instruction 322.

In this illustrative example, global prediction 328 may be implemented in a manner similar to local prediction 326. In other words, global prediction 328 may also be identified using a set of bits. However, global prediction 328 may include more than one set of bits per branch instruction. In this manner, global prediction 328 may take into account the path taken to reach the branch instruction.

Global history vector 223 in FIG. 2 is a vector that stores recent paths of instruction processing. In this illustrative example, global history vector 223 is used to make global prediction 328. Global prediction 328 may be indexed by the effective address of the branch instruction exclusive ORed with the global history vector.

A selector may indicate whether to use local prediction 326 or global prediction 328. For example, the selector may indicate to the processor to use the local prediction instead of the global prediction. The selector may be indexed by the effective address of the branch instruction exclusive ORed with the global history vector. In this manner the process may have more than one selector for each branch instruction.

Global prediction 328 may be located in branch history table 332. Branch history table 332 may include global prediction 328 and other global predictions for other instructions in addition to branch instruction 322. A prediction for branch instruction 322 located in branch history table 332 may be associated with branch instruction 322 in a number of different ways. For example, a pointer or address may be used to indicate that a particular prediction in global prediction 328 is to be associated with or correspond to branch instruction 322. In these illustrative examples, branch history table 332 is not a cache. In other words, predictions may be looked up in branch history table 332 based on the effective address of the branch instruction and the global history vector. Further, branch history table 332 includes a number of predictions for each branch instruction based on the path of processing taken to reach the branch instruction.

In the illustrative examples, trace unit 308 generates current segment 334. Trace unit 308 begins generating current segment 334 when the effective address for the first branch instruction to be included in current segment 334 is reached in the processing of instructions 306. The effective address for the first branch instruction may be stored in a data structure by hardware in trace unit 308.

During processing of the branch instructions, if the result of processing branch instruction 322 follows the trace path indicated by prediction 324, branch instruction 322 is added to current segment 334. Current segment 334 is a segment that is currently being processed or generated in trace 312.

Additional branch instructions that are processed after processing branch instruction 322 are also added to current segment 334 depending on whether the processing of the additional branch instructions follows the trace path indicated for the additional branch instructions. This addition of branch instructions to current segment 334 occurs while the subsequent branch instructions follow predictions for the subsequent branch instructions.

Additionally, in the depicted examples, subsequent branch instructions are added to current segment 334 only when a number of conditions are met. For example, if the subsequent branch instruction is a non-indirect branch instruction, the branch instruction must follow the local prediction. If the subsequent branch instruction is an indirect branch instruction, the branch instruction must follow the address stored in the local count cache. Further, if the subsequent branch instruction is a branch return branch instruction, the branch call branch instruction leading to the branch return branch instruction must be present in current segment 334. Additionally, the subsequent branch instruction is added only when the subsequent branch instruction is not already part of current segment 334. In other words, if the effective address for the subsequent branch instruction is an effective address that has previously been encountered while generating trace 312, then trace 312 is ended without adding the subsequent branch instruction to current segment 334. In this manner, trace 312 does not contain a loop of instructions.

In these examples, current segment 334 is part of set of segments 336. These segments are part of trace 312. A “set”, as used herein, when referring to items, means “one or more items”. For example, a “set of segments” is “one or more segments”.

In response to the result not following the prediction for branch instruction 322, branch instruction 322 is added to current segment 334. Current segment 334 is now complete. In other words, current segment 334 is ended and trace unit 308 generates first new segment 338 and second new segment 340 are generated. First new segment 338 includes first new branch instruction 342 in instructions 306 reached from following prediction 324 in processing instructions 306. Second new segment 340 includes second new branch instruction 344 in instructions 306 reached from not following prediction 324 when processing instructions 306. Current segment 334 is now second new segment 340, and trace unit 308 tracks second new segment 340. Further, trace unit 308 tracks first new segment 338 when the first branch instruction in first new segment 338 is reached in subsequent processing.

For example, first new segment 338 with first new branch instruction 342 may be the instruction for when the branch is not taken, while second new segment 340 with second new branch instruction 344 may be for the branch taken. First new segment 338 and second new segment 340 are then processed in the same manner as current segment 334. In other words, additional branch instructions may be added to these segments when the results of the processing of branch instructions follow the predicted paths associated with those branch instructions and meet the number of conditions as described above.

In these depicted examples, prediction 324 may be identified using, for example, branch history table 332. For example, a set of paths for the processing of instructions 306 may be identified. The set of paths may be the predicted set of paths for the processing of instructions 306. The identification of the set of paths may be made and prediction 324 formed using at least one of branch history table 332, local prediction 326, global prediction 328, a link stack, a selector, and count cache 351 associated with branch history table 332. In this illustrative example, branch instruction 322 may only be added to current segment 334 when local prediction 326, the local count cache in count cache 351, and the link stack are used to identify prediction 324 for branch instruction 322.

Some branch instructions, such as branch call branch instructions and branch return branch instructions, use a link stack. When a branch call is made by a branch call branch instruction, the effective address of the instruction after the branch call branch instruction is pushed onto the link stack. When a branch return is made by a branch return branch instruction, the link stack is popped to provide the effective address of a target address for the branch return branch instruction.

In this illustrative example, the branch call branch instruction and the branch return branch instruction are considered to be paired or associated with each other. A branch call branch instruction and a branch return branch instruction may be required to be in the same segment. In other words, a segment is ended when a branch return branch instruction is reached that does not have branch call branch instruction in the same segment.

Count cache 351 stores the addresses of the target instructions for indirect branch instructions in branch instructions 320. In these examples, count cache 351 may comprise a local count cache and a global count cache. The addresses of the target instructions stored in the local count cached may be indexed by the effective address of the indirect branch instruction. The addresses of the target instructions stored in the global count cache may be indexed by the effective address of the indirect branch instruction exclusive ORed with the global history vector.

In these illustrative examples, only local prediction 326, the local count cache in count cache 351, and the link stack may be used to identify prediction 324 for branch instruction 322. In particular, local prediction 326, the local count cache in count cache 351, and the link stack are used to indicate trace path 355 for branch instructions 322. Trace path 355, in these illustrative examples, includes at least a portion of branch instructions 320. Further, trace path 355 is indicated when a desired strength for local prediction 326 is reached.

In these illustrative examples, this type of processing of branch instructions 320 within instructions 306 may be initiated in response to event 346. For example, event 346 may be selected instruction 348 that identifies address 350 as an address where trace 312 should be started. Address 350 may be a branch instruction or some other instruction, depending on the particular implementation. Event 346 also may be, for example, without limitation, a signal indicating a time to start processing, the occurrence of an exception in processing, and/or other suitable events. In some illustrative examples, event 346 may be a signal that indicates both a time to start processing and/or a time to stop processing. In other illustrative examples, event 346 may be a signal that indicates a time to start processing and a duration of time for processing.

Further, this type of processing of branch instructions 320 may also be stopped in response to event 346. Event 346 may be, for example, a signal indicating a time to stop processing, the completion of the processing of a selected number of branch instructions, and/or some other suitable type of event.

The processing of instructions 306 may occur multiple times. In the subsequent processing of instructions 306 after set of segments 336 have been created, set of segments 336 may be modified, depending on whether the result of processing branch instructions 320 follows the paths indicated by set of segments 336 for those branch instructions. For example, in response to processing instructions 306 at a subsequent time, a determination is made as to whether a particular result generated from processing selected branch instruction 352 in segment 354 in trace 312 follows particular path 357 for selected branch instruction 352. Particular path 357 is the path indicated by segment 354 for selected branch instruction 352. If the result does not follow particular path 357, segment 354 may be changed to end after selected branch instruction 352, even if other branch instructions may be present after selected branch instruction 352. In other words, segment 354 may be divided into two parts.

In some illustrative examples, each of set of segments 336 may have an identifier, such as identifier 356. Identifier 356 may be used to distinguish between the different segments in set of segments 336. For example, identifier 356 may be the address of the first branch instruction of a segment in set of segments 336.

Additionally, in these illustrative examples, statistics about the processing of branch instructions may be stored in a data structure in a storage device in processor unit 302 while information about set of segments 336 for trace 312 is collected. The data structure may store information indicating the number of times the branch indicated by a branch instruction is taken and/or not taken, the number of times a branch instruction does not follow a prediction, and/or other suitable information.

The illustration of instruction processing environment 300 in FIG. 3 is not meant to imply physical or architectural limitations to the manner in which different illustrative embodiments may be implemented. Other components in addition and/or in place of the ones illustrated may be used. Some components may be unnecessary in some illustrative embodiments. Also, the blocks are presented to illustrate some functional components. One or more of these blocks may be combined and/or divided into different blocks when implemented in different illustrative embodiments.

For example, in the different illustrative embodiments, other instructions in addition to instructions 306 may be present for program 304. Additionally, trace 312 may include other information in addition to set of segments 336. For example, trace 312 also may include timestamps, processing times, and other suitable information.

For example, in some illustrative embodiments, instructions 306 may be for a module, a portion of the program, or some other form of instructions. In still other illustrative embodiments, instructions 306 may be processed with multiple processor units on different computers working cooperatively. Each processor unit may include hardware for creating traces in accordance with illustrative embodiments.

In other illustrative examples, instructions 306 may be processed a number of times in parallel. In other words, more than one of trace 312 may be formed at the same time for instructions 306. For example, two traces may be generated when processing instructions 306 concurrently.

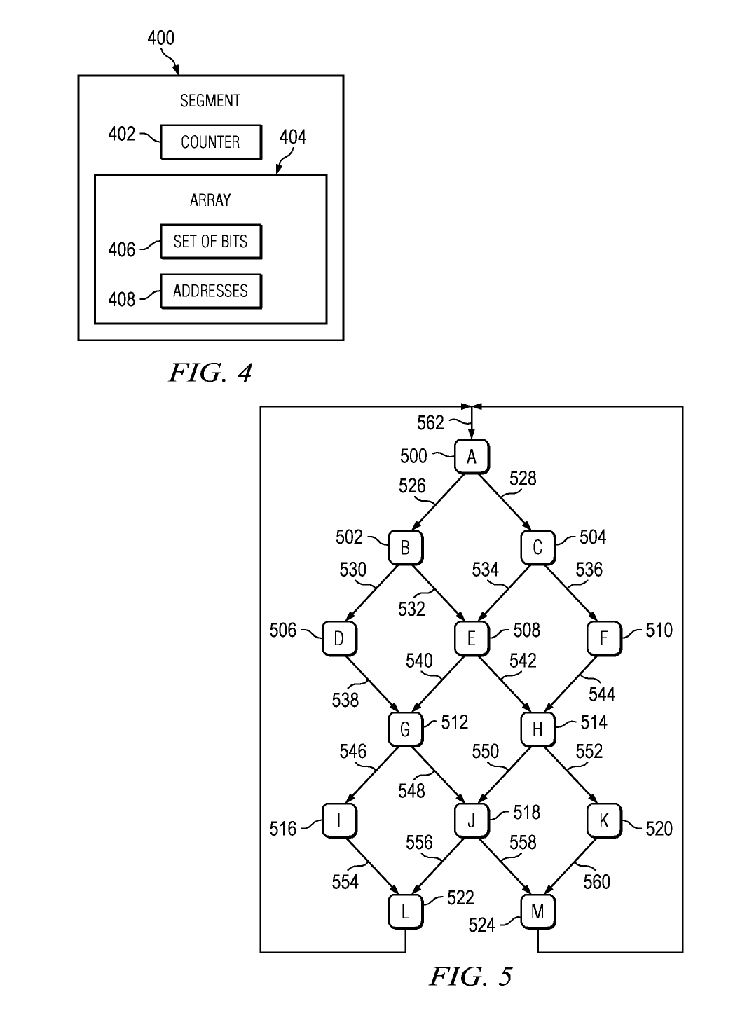

With reference now to FIG. 4, an illustration of a segment is depicted in accordance with an illustrative embodiment. Segment 400 is an example of one implementation for a segment in set of segments 336 in FIG. 3. As depicted, segment 400 includes counter 402 and array 404.

Counter 402 identifies the number of branch instructions in segment 400. Every branch instruction in segment 400 is for a branch instruction in which a branch is taken or not taken that follows the path indicated by segment 400 for the particular branch instruction.

Array 404 provides an identification of whether a branch is taken or not taken for each branch instruction. Array 404, in these examples, may take the form of set of bits 406. For example, a bit may be set to a logical one if the branch is taken. If the branch is not taken, the bit may be set to a logic zero. Of course, in other illustrative examples, array 404 may include other information in addition to or in place of set of bits 406. For example, addresses 408 for each of the branch instructions may be present in array 404.

In other illustrative examples, segment 400 may only include counter 402 to keep track of the number of branch instructions in segment 400. In these examples, the identification of whether a branch is taken or not taken is not provided by segment 400. Instead, this identification may be inferred using the information in the branch history table, the count cache, and the state of the link stack. In this illustrative example, the trace path may be identified using existing hardware mechanisms for forming traces.

With reference now to FIG. 5, a diagram illustrating branch instructions is depicted in accordance with an illustrative embodiment. In this example, branch instructions 500, 502, 504, 506, 508, 510, 512, 514, 516, 518, 520, 522, and 524 are depicted. These branch instructions are examples of branch instructions 320 in instructions 306 in FIG. 3.

As can be seen, different paths may be taken in the processing of the branch instructions. These paths may include branches that are taken or not taken as indicated by the branch instructions.

For example, branch instructions 500 may indicate that either a branch is taken or a branch is not taken. If a branch is not taken, branch instruction 500 leads to sequence of instructions 526. If a branch is taken, branch instruction 500 leads to sequence of instructions 528. Sequence of instructions 526 leads to branch instruction 502. Sequence of instructions 528 leads to branch instruction 504.

In these illustrative examples, a sequence of instructions is one or more instructions. One instruction leads to another instruction in the sequence of instructions without any branches being taken. In other words, the sequence of instructions does not include any branch instructions.

When a branch is not taken from branch instruction 502, branch instruction 502 leads to sequence of instructions 530 that leads to branch instruction 506. When a branch is taken from branch instruction 502, branch instruction 502 leads to sequence of instructions 532 that leads to branch instruction 508. When a branch is not taken from branch instruction 504, branch instruction 504 leads to sequence of instructions 534 that leads to branch instruction 508. When a branch is taken from branch instruction 504, branch instruction 504 leads to sequence of instructions 536 that leads to branch instruction 510.

When a branch is not taken from branch instruction 506, branch instruction 506 leads to a sequence of instructions (not shown) that leads to branch instruction 504. When a branch is taken from branch instruction 506, branch instruction 506 leads to sequence of instructions 538 that leads to branch instruction 512. When a branch is not taken from branch instruction 508, branch instruction 508 leads to sequence of instructions 540 that leads to branch instruction 512. When a branch is taken from branch instruction 508, branch instruction 508 leads to sequence of instructions 542 that leads to branch instruction 514. When a branch is not taken from branch instruction 510, branch instruction 510 leads to sequence of instructions 544 that leads to branch instruction 514. When a branch is taken from branch instruction 510, branch instruction 510 leads to a sequence of instructions (not shown) that leads to branch instruction 520.

When a branch is not taken from branch instruction 512, branch instruction 512 leads to sequence of instructions 546 that leads to branch instruction 516. When a branch is taken from branch instruction 512, branch instruction 512 leads to sequence of instructions 548 that leads to branch instruction 518. When a branch is not taken from branch instruction 514, branch instruction 514 leads to sequence of instructions 550 that leads to branch instruction 518. When a branch is taken from branch instruction 514, branch instruction 514 leads to sequence of instructions 552 that leads to branch instruction 520.

When a branch is not taken from branch instruction 516, branch instruction 516 leads to a sequence of instructions (not shown) that leads to branch instruction 510. When a branch is taken from branch instruction 516, branch instruction 516 leads to sequence of instructions 554 that leads to branch instruction 522. When a branch is not taken from branch instruction 518, branch instruction 518 leads to sequence of instructions 556 that leads to branch instruction 522. When a branch is taken from branch instruction 518, branch instruction 518 leads to sequence of instructions 558 that leads to branch instruction 524. When a branch is not taken from branch instruction 520, branch instruction 520 leads to sequence of instructions 560 that leads to branch instruction 524. When a branch is taken from branch instruction 520, branch instruction 520 leads to a sequence of instructions (not shown) that leads to branch instruction 500.

In this illustrative example, branch instruction 522 and branch instruction 524 are unconditional branch instructions. In other words, the branches indicated by branch instruction 522 and branch instruction 524 are always taken. For example, a branch is always taken from branch instruction 522 that leads to sequence of instructions. Additionally, a branch is always taken from branch instruction 524 that leads to sequence of instructions 562. Sequence of instructions 562 leads to branch instruction 500.

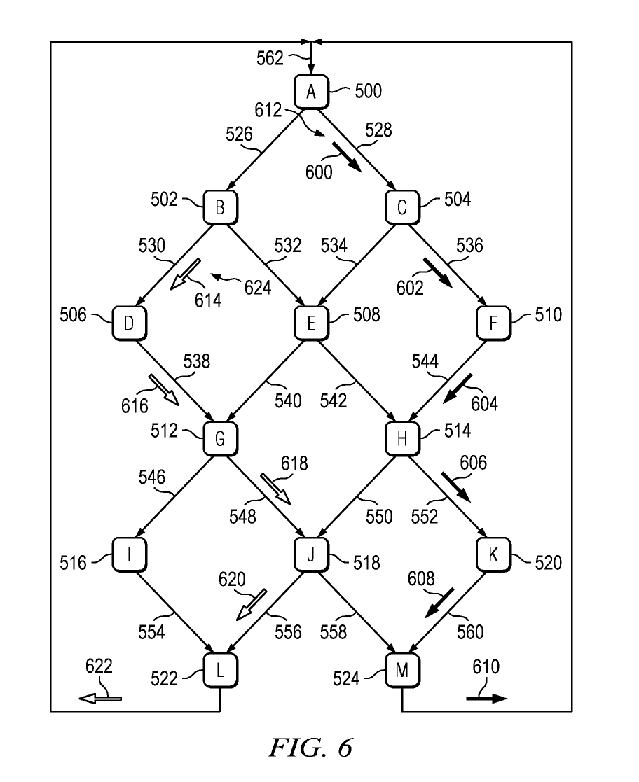

With reference now to FIG. 6, an illustration of a path for processing branch instructions is depicted in accordance with an illustrative embodiment. In this illustrative example, arrows 600, 602, 604, 606, 608, and 610 indicate trace path 612 for the processing of the branch instructions from branch instruction 500. Further, arrows 614, 616, 618, 620, and 622 indicate trace path 624 for the processing of the branch instructions from branch 502.

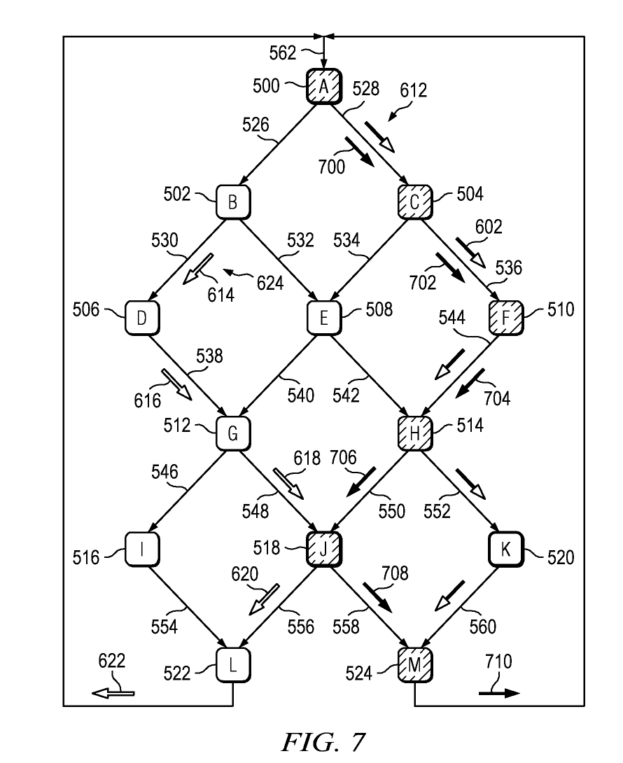

With reference now to FIG. 7, an illustration of a path taken through branch instructions during processing of branch instructions is depicted in accordance with an illustrative embodiment. In FIG. 7, arrows 700, 702, 704, 706, 708, and 710 illustrate the paths actually taken during processing of the instructions. In this example, arrows 700, 702, and 704 follow the portion of trace path 612 indicated by arrows 600, 602, and 604 in FIG. 6.

Arrow 706 indicates that the processing of branch instruction 514 does not lead to sequence of instructions 552 as predicted by arrow 606 in FIG. 6 to branch instruction 520. Instead, the processing of branch instruction 514 results in a branch being taken that leads to sequence of instructions 550 that leads to branch instruction 518.

In this illustrative example, trace unit 308 in FIG. 3 is used to create a segment that includes branch instruction 500, branch instruction 504, branch instruction 510, and branch instruction 514. As depicted, branch instruction 500 is the beginning of this segment.

Additionally, in response to the processing of branch instruction 514 not leading to sequence of instructions 552 as predicted by trace path 612, the trace unit forms two new segments. The first new segment begins with the branch instruction that follows trace path 612 in FIG. 6. In other words, the first new segment begins with branch instruction 520.

The second new segment begins with the branch instruction that is actually reached from processing of branch instruction 514. In other words, the second new segment begins with branch instruction 518. Additionally, the second new segment includes branch instruction 524 because processing of branch instruction 528 leads to sequence of instructions 558 as predicted by trace path 624.

Although the processing of branch instruction 524 leads to branch instruction 500, branch instruction 500 is not added to the second new segment because branch instruction 500 is the beginning of a segment. In other words, the second new segment ends with branch instruction 528.

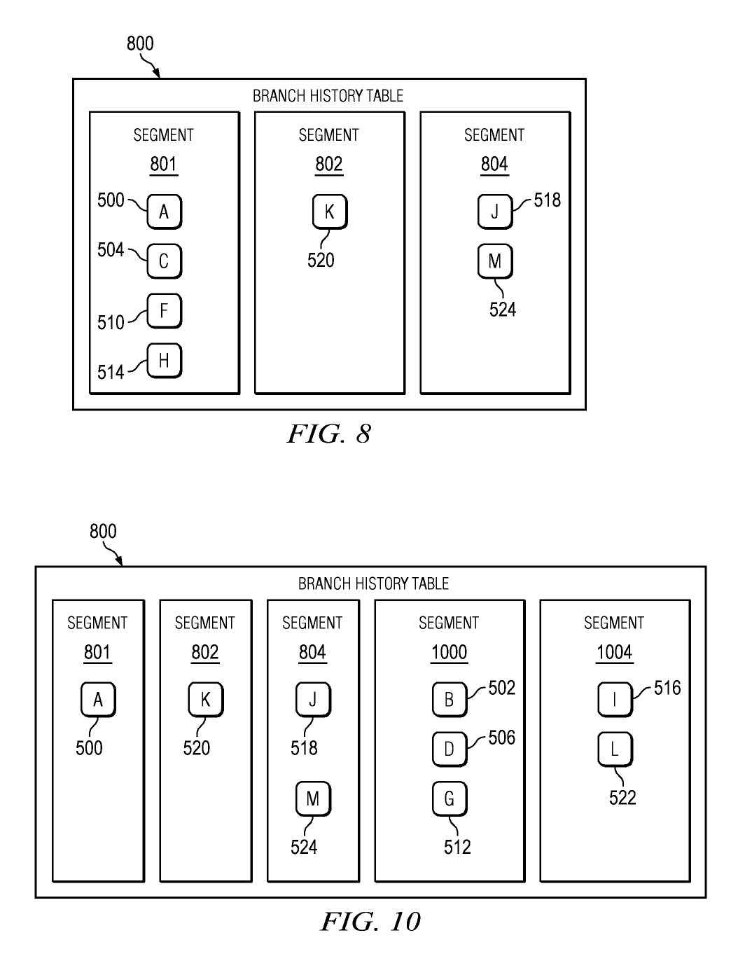

With reference now to FIG. 8, an illustration of a branch history table containing segments generated by processing instructions in FIG. 7 is depicted in accordance with an illustrative embodiment. In this example, branch history table 800 includes segment 801. Segment 801 is generated in response to the path taken during the processing of branch instructions in FIG. 7. As illustrated, segment 801 includes branch instructions 500, 504, 510, and 514. Further, segment 801 is indexed by the effective address of branch instruction 500 in this illustrative example.

Branch instructions 500, 504, and 510 are branch instructions in which the result of processing those branch instructions follows a prediction for those branch instructions. The processing of branch instruction 514 has a result from processing of branch instruction 514 that does not follow a prediction for branch instruction 514. The prediction for branch instruction 514 is for a branch to be taken to branch instruction 520. In processing branch instruction 514, a branch is not taken that leads to branch instruction 518. Branch instruction 514 is included in segment 801, but the result of branch instruction 514 not following a prediction as to whether a branch in processing is predicted to occur results in the completion of segment 801.

Then, two segments are created in slots in branch history table 800 in absence of the result of the processing of branch 514 following the prediction for branch 514. A first new segment in the trace is created in which the first new segment includes a first branch instruction reached in the instructions from following the prediction. In this example, segment 802 is the first new segment created and includes branch instruction 520. Segment 802 is indexed by the effective address of branch instruction 520 in this illustrative example.

A second new segment is created in the trace in which the second new segment includes a branch instruction in the instruction's reach from not following the prediction. In this example, segment 804 is the second new segment created and includes branch instruction 518 and branch instruction 524. Segment 804 is indexed by the effective address of branch instruction 518 in this illustrative example.

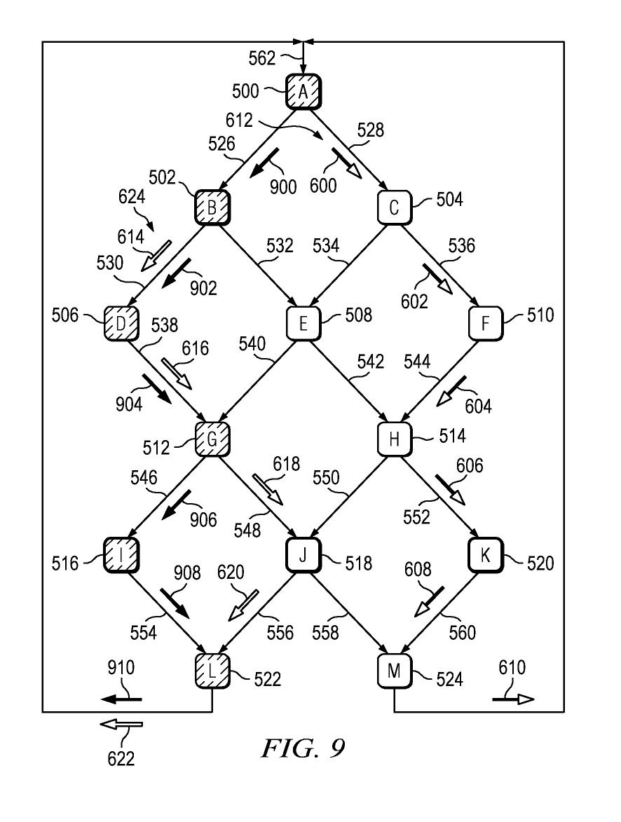

With reference to FIG. 9, an illustration of the processing of branch instructions a second time is depicted in accordance with an illustrative embodiment. In FIG. 9, arrows 900, 902, 904, 906, 908, and 910 illustrate the path taken when processing the branch instructions a second time.

In this illustration, the processing of branch instruction 500 does not follow the prediction for branch instruction 500. The processing of branch instructions 502 and 506 do follow the predictions for those branch instructions as predicted by trace path 624 in FIG. 6. The processing of branch instruction 512 does not follow the prediction for branch instruction 512 as predicted by trace path 624.

With reference now to FIG. 10, an illustration of a branch history table containing segments is depicted in accordance with an illustrative embodiment. This figure illustrates the modification of segments depicted in FIG. 8 in response to processing of instructions in the manner described in FIG. 9.

In this example, segment 801 includes branch instruction 500. The processing of branch instruction 500 the second time has a result that does not follow the prediction for branch instruction 500. Segment 801 no longer includes branch instructions 504, 510, and 514. As a result, segment 801 is changed to end after branch instruction 500.

In the processing of branch instructions in FIG. 9, segment 1000 is generated. Segment 1000 includes branch instruction 502, branch instruction 506, and branch instruction 512. Segment 1000 is indexed by the effective address of branch instruction 502 in this illustrative example. Branch instructions 502 and 506 have results from processing that follow the predictions for those branch instructions. Branch instruction 512 has a result that does not follow the prediction for branch instruction 512. As a result, branch instruction 512 is the last branch instruction included in segment 1000.

Additionally, two new segments can be generated based on the paths that can be taken from branch instruction 512. One of these new segments would begin with branch instruction 518, the first branch instruction that can be reached in the instructions if the prediction for branch instruction 512 is followed. However, segment 804 is already present in branch history table 800 and indexed by the effective address of branch instruction 518. A new segment is not created that begins with branch instruction 518.

A new segment is created containing the first branch instruction in the instructions that are reached from not following the prediction for branch instruction 512. Segment 1004 is created as the new segment. In this example, branch instruction 516 is present in segment 1004. Segment 1004 is indexed by the effective address of branch instruction 516. Additionally, the processing of branch instruction 516 leads to branch instruction 522, which follows a prediction for branch instruction 516. Branch instruction 522 is included in segment 1004.

Although the processing of branch instruction 522 leads to branch instruction 500, branch instruction 500 is not included in segment 1004 because branch instruction 500 is the beginning of segment 801. In other words, segment 1004 ends with branch instruction 522.

The illustration of the branch instructions and the segments created from branch instructions, as well as modifications to the branch instructions illustrated in FIGS. 5-10, is presented for purposes of illustrating one manner in which segments may be created and changed in accordance with an illustrative embodiment. These illustrations are not meant to imply limitations to the manner in which segments may be created and what branch instructions may be processed. For example, in other illustrative embodiments, other numbers of branch instructions or other predictions for branch instructions may be used. Further, in other illustrative embodiments, additional passes may be made with respect to the branch instructions, which may result in further modifications of segments already created and the creation of new segments in accordance with the illustrative embodiments.

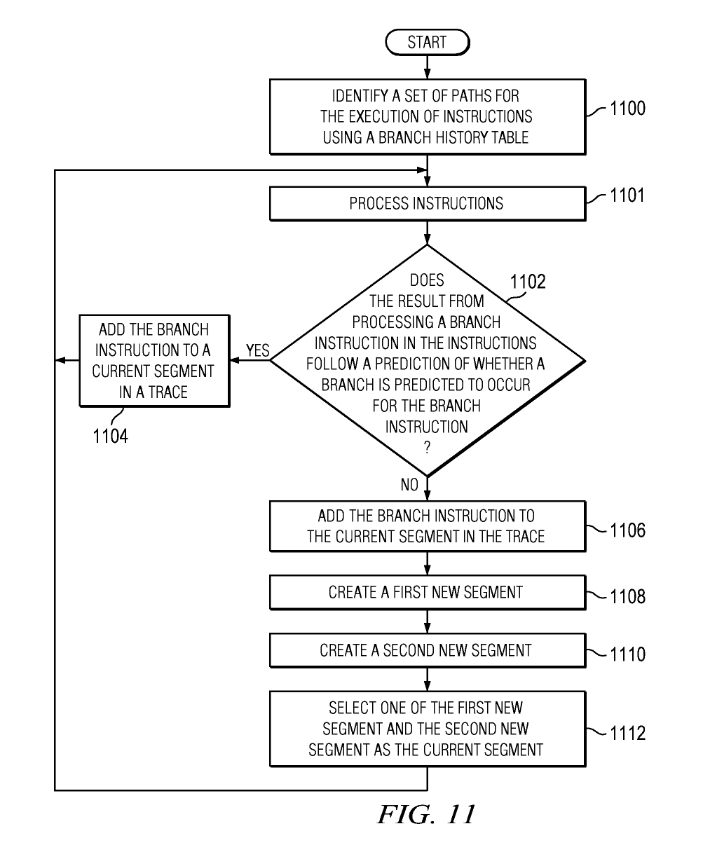

With reference next to FIG. 11, an illustration of a high-level flowchart of a process for obtaining information about instructions processed by a processor unit is depicted in accordance with an illustrative embodiment. The process illustrated in FIG. 11 may be implemented in hardware in processor unit 302 in FIG. 3. The different steps may be implemented in hardware and/or software in processor unit 302 in FIG. 3. For example, the process in this figure may be implemented in trace unit 308 in processor unit 302 in FIG. 3.

The process begins by a processor unit identifying a set of paths for the processing of instructions using a branch history table (step 1100). The set of paths identified may indicate a predicted set of paths for the processing of the instructions. In other words, the set of paths may indicate predictions for whether branches are to be taken when processing the instructions. In these illustrative examples, the set of paths may be also identified using a count cache associated with the branch history table.

The processor unit then processes the instructions (step 1101). In response to the processor unit processing a branch instruction in the instructions, the processor unit determines whether a result from processing the branch instruction follows a prediction of whether a branch is predicted to occur for the branch instruction (step 1102). In these illustrative examples, the identification of the prediction may be made using a local prediction, a global prediction, or a combination of the two. The prediction of whether a branch should occur for the branch instruction is compared to the actual result in processing the branch instruction.

In response to a result following the prediction, the processor unit adds the branch instruction to a current segment in a trace (step 1104), with the process returning to step 1101, as described above. The current segment includes an identification of a set of branch instructions in which each result for each branch instruction in the segment follows a corresponding prediction for the branch instruction. In other words, all of the branch instructions in the segment have results that followed the predictions for those branch instructions.

With reference again to step 1102, if the result does not follow the prediction, the processor unit adds the branch instruction to the current segment in the trace (step 1106). In addition, the processor unit creates a first new segment in the trace (step 1108). This first new segment includes a first new branch instruction reached in the instructions from following the prediction. The processor unit creates a second new segment in the trace (step 1110). The second new segment includes a second new branch instruction in the instructions reached from not following the prediction. The process then selects one of the first new segments and the second new segment as the current segment (step 1112), with the process returning to step 1101, as described above. In step 1112, the segment selected as the current segment is the segment containing the particular branch instruction that is reached from the result in step 1102.

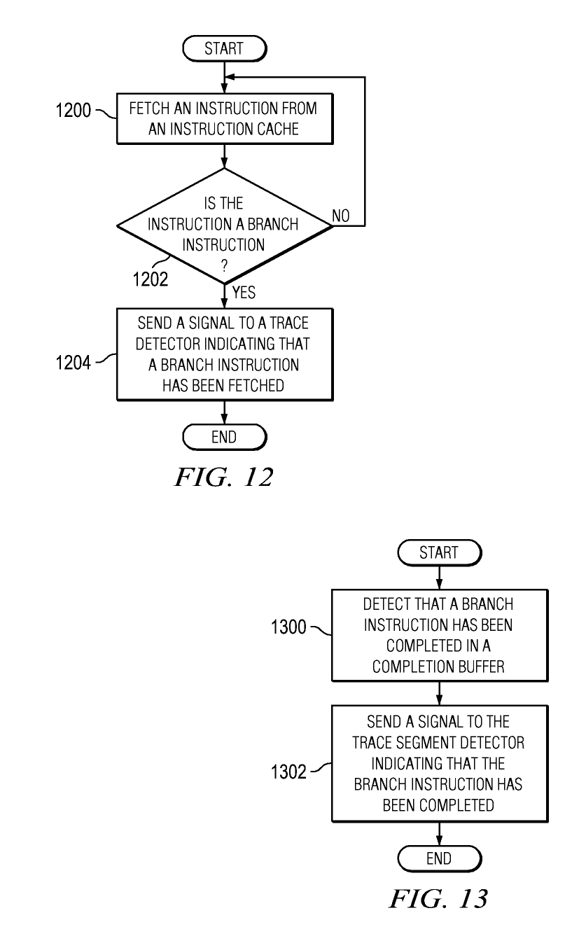

With reference now to FIG. 12, an illustration of a flowchart of a process for fetching a branch instruction is depicted in accordance with an illustrative embodiment. The process illustrated in FIG. 12 may be implemented in hardware and/or software in processor unit 210 in FIG. 2 and in processor unit 302 in FIG. 3. For example, the different steps in this process may be implemented using sequencer unit 218 in FIG. 2.

The process begins by fetching an instruction from an instruction cache (step 1200). The instruction cache may be, for example, without limitation, instruction cache 214 in processor unit 210 FIG. 2. The process then determines whether the instruction fetched is a branch instruction (step 1202). For example, the process determines whether the instruction is a branch instruction, such as one of branch instructions 320 in FIG. 3.

If the instruction is not a branch instruction, the process returns to step 1200 as described above. Otherwise, if the instruction is a branch instruction, the process sends a signal to a trace segment detector indicating that a branch instruction has been fetched (step 1204), with the process terminating thereafter. The trace segment detector may be, for example, trace segment detector 242 in FIG. 2. In this illustrative example, the signal may indicate that the fetched branch instruction is ready to be processed by the trace segment detector.

With reference now to FIG. 13, an illustration of a flowchart of a process for detecting whether a branch instruction has been completed is depicted in accordance with an illustrative embodiment. The process illustrated in FIG. 13 may be implemented in hardware and/or software in processor unit 210 in FIG. 2 and in processor unit 302 in FIG. 3. For example, the different steps in this process may be implemented using sequencer unit 218 in FIG. 2.

The process begins by detecting that a branch instruction has been completed in a completion buffer (step 1300). The completion buffer may be, for example, completion buffer 248 in FIG. 2. The completion buffer stores information indicating whether the branch instruction has been completed. Thereafter, the process sends a signal to the trace segment detector indicating that the branch instruction has been completed (step 1302), with the process terminating thereafter.

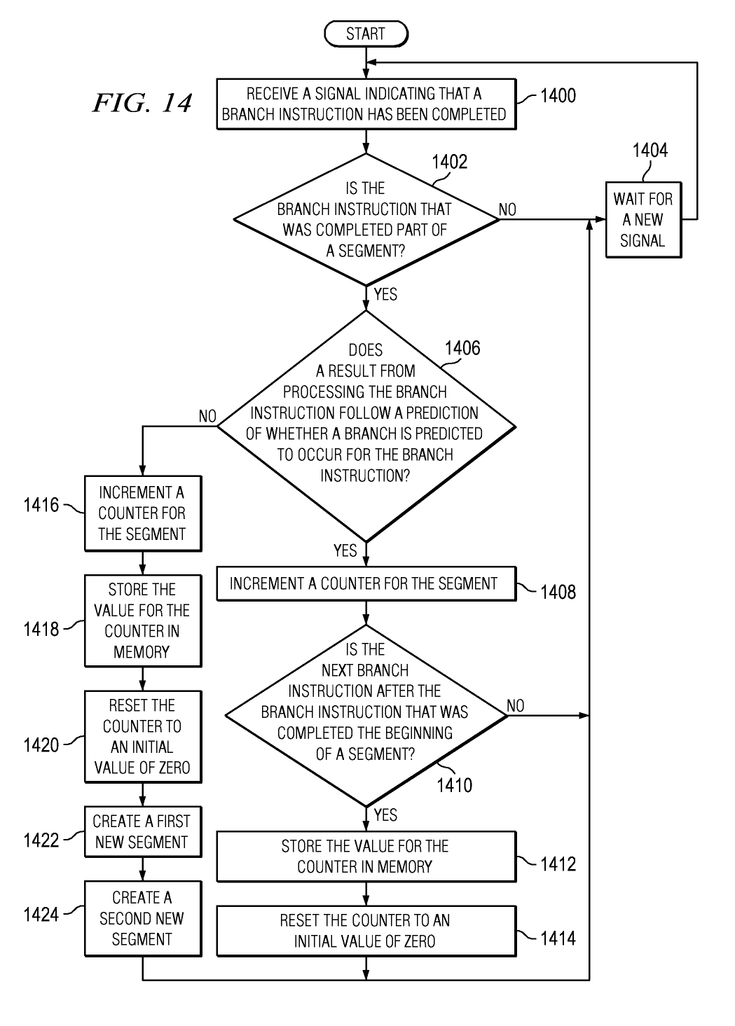

With reference now to FIG. 14, an illustration of a flowchart of a process for generating information when processing instructions is depicted in accordance with an illustrative embodiment. The process illustrated in FIG. 14 may be implemented in hardware and/or software in processor unit 210 in FIG. 2 and in processor unit 302 in FIG. 3. For example, the different steps in this process may be implemented using tracer segment detector 242 in FIG. 2 and/or trace unit 308 in FIG. 3.

The process receives a signal indicating that a branch instruction has been completed (step 1400). This signal may be received from a sequencer unit. For example, the trace unit may receive the signal sent by sequencer unit in step 1302 in FIG. 13. The process then determines whether the branch instruction that was completed is part of a segment (step 1402). In step 1402, this determination may be made by searching for an identifier in the signal received in step 1400. The identifier may identify the particular segment to which the branch instruction belongs. In this manner, step 1402 includes identifying the segment to which the branch instruction belongs.

If the branch instruction is not part of a segment, the process waits for a new signal (step 1404). When the new signal is received, the process then returns to step 1400 as described above. In step 1402, if the branch instruction is part of a segment, the process determines whether a result from processing the branch instruction followed the prediction of whether a branch is predicted to occur for the branch instruction (step 1406).

If the result from processing the branch instruction followed the prediction, the process increments a counter for the segment (step 1408). In step 1408, the counter may be set to an initial value of zero before any increments are made to the counter in this process. Step 1408 is performed to calculate the number of branch instructions in the segment. In some illustrative examples, some other technique other than incrementing a counter may be used to calculate the number of branches in the segment.

The process then determines whether the next branch instruction after the branch instruction that was completed the beginning of a segment (step 1410). In step 1410, the segment may be the current segment or a new segment.

If the next branch instruction is not the beginning of a segment, the process continues to step 1404 as described above. Otherwise, the process stores the value for the counter in memory (step 1412). In particular, in step 1412, the value for the counter is stored in a register. Thereafter, the process resets the counter to an initial value of zero (step 1414). The end of the segment has been reached. The process then continues to step 1404 as described above.

With reference again to step 1406, if the result from processing the branch instruction did not follow the prediction, the process increments the counter for the segment (step 1416). The process then stores the value for the counter in memory (step 1418). The process resets the counter to an initial value of zero (step 1420). The end of the segment has been reached.

Thereafter, the process creates a first new segment (step 1422). The first new segment begins with the branch instruction reached from following the prediction. The process then creates a second new segment (step 1424). The second new segment begins with the branch instruction reached from not following the prediction. Thereafter, the process continues to step 1404 as described above.

In these different illustrative examples, after the segments have been created, the trace paths for the segments are collected using some suitable type of trace path collection process that can be accessed by a software tool, such as software tool 314 in FIG. 3.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more instructions for implementing the specified logical function(s). It should also be noted that, in some alternative implementations, the functions noted in the block may occur out of the order noted in the figures. For example, two blocks shown in succession may, in fact, be performed substantially concurrently, or the blocks may sometimes be performed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The invention can take the form of an entirely hardware embodiment, an entirely software embodiment or an embodiment containing both hardware and software elements. In an illustrative embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction processing system. For the purposes of this description, a computer-usable or computer readable medium can be any tangible apparatus that can contain, store, communicate, propagate, or transport the program for use by or in connection with the instruction processing system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or running program code will include at least one processor coupled directly or indirectly to memory elements through a system bus. The memory elements can include local memory employed during actual processing of the program code, bulk storage, and cache memories which provide temporary storage of at least some program code in order to reduce the number of times code must be retrieved from bulk storage during processing.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for obtaining information about instructions, the method comprising:
processing, by a processor unit, instructions;
responsive to processing a branch instruction in the instructions, determining, by the processor unit, whether a result from processing the branch instruction follows a prediction of whether a branch is predicted to occur for the branch instruction;
responsive to the result following the prediction, adding, by the processor unit, the branch instruction to a current segment in a trace, wherein the current segment includes an identification of a set of branch instructions in which each result for each branch instruction in the current segment follows a corresponding prediction for the each branch instruction;
responsive to an absence of the result following the prediction, adding, by the processor unit, the branch instruction to the current segment in the trace; and
responsive to an absence of the result following the prediction, creating, by the processor unit, a first new segment in the trace in which the first new segment includes a first branch instruction reached in the instructions from following the prediction and a second new segment in the trace in which the second new segment includes a second branch instruction in the instructions reached from not following the prediction.

2. The method of claim 1 further comprising:
identifying, by the processor unit, which new branch instruction is reached from the result of the branch instruction to form an identified branch instruction, wherein the new branch instruction is selected from one of the first new branch instruction and the second new branch instruction; and
setting, by the processor unit, a particular segment from one of the first new segment and the second new segment that contains the identified branch instruction as the current segment.

3. The method of claim 2 further comprising:
returning, by the processor unit, to the processing step after setting the particular segment.

4. The method of claim 1 further comprising:
repeating, by the processor unit, the determining and adding steps while subsequent results for subsequent branch instructions in the instructions follow predictions for the subsequent branch instructions.

5. The method of claim 1 further comprising:
responsive to processing the instructions at a subsequent time, determining, by the processor unit, whether a particular result generated from processing a selected branch instruction in a segment in the trace follows a particular prediction for the selected branch instruction in the segment; and
responsive to an absence of the particular result following the particular prediction for the selected branch instruction, changing, by the processor unit, the segment to end after the selected branch instruction.

6. The method of claim 1, wherein the adding step comprises:
incrementing, by the processor unit, a counter for the segment.

7. The method of claim 1, wherein the adding step further comprises:
setting, by the processor unit, a value in an array in a location in the array that corresponds to the branch instruction.

8. The method of claim 1 further comprising:
responsive to processing a particular instruction identifying an address for an instruction in the instructions, initiating, by the processor unit, the determining step when the instruction at the address is processed.

9. The method of claim 1, wherein the prediction of whether the branch in processing is predicted to occur for the branch instruction is selected from at least one of an instruction in the instructions and an entry in a branch history table.

10. The method of claim 1 further comprising:
modifying, by a software tool, a portion of the instructions using the trace to increase performance in processing the instructions.

11. The method of claim 1 further comprising:
identifying a set of paths for processing of the instructions using at least one of the branch history table and the current segment.

12. The method of claim 1, wherein the prediction is a local prediction in which at least one of the local prediction, a local count cache, and a link stack is used to indicate a trace path for processing the branch instructions.

13. A data processing system comprising:
a bus system;
a communications unit connected to the bus;
a storage device connected to the bus, wherein the storage device includes program code; and
a processor unit connected to the bus, wherein the processor unit runs the program code to process instructions; determine whether a result from processing the branch instruction follows a prediction of whether a branch is predicted to occur for the branch instruction in response to processing a branch instruction in the instructions; add the branch instruction to a current segment in a trace in response to the result following the prediction, wherein the current segment includes an identification of a set of branch instructions in which each result for each branch instruction in the current segment follows a corresponding prediction for the each branch instruction; add the branch instruction to the current segment in the trace in response to an absence of the result following the prediction; and create a first new segment in the trace in which the first new segment includes a first branch instruction reached in the instructions from following the prediction and a second new segment in the trace in which the second new segment includes a second branch instruction in the instructions reached from not following the prediction in response to an absence of the result following the prediction.

14. The data processing system of claim 13, wherein the processor unit further runs the program code to identify which new branch instruction is reached from the result of the branch instruction to form an identified branch instruction, wherein the new branch instruction is selected from one of the first new branch instruction and the second new branch instruction; and set a particular segment from one of the first new segment and the second new segment that contains the identified branch instruction as the current segment.

15. The data processing system of claim 14, wherein the processor unit further runs the program code to return to the running the program code to process the instructions after setting the particular segment.

16. The data processing system of claim 13, wherein the processor unit further runs the program code to determine whether a particular result generated from processing a selected branch instruction in a segment in the trace follows a particular prediction for the selected branch instruction in the segment in response to processing the instructions at a subsequent time; and change the segment to end after the selected branch instruction in response to an absence of the particular result following the particular prediction for the selected branch instruction.

17. A computer program product obtaining information about instructions comprising:
computer readable storage media;
program code, stored on the computer readable storage media, for processing instructions;
program code, stored on the computer readable storage media, for determining whether a result from processing the branch instruction follows a prediction of whether a branch is predicted to occur for the branch instruction in response to processing a branch instruction in the instructions;
program code, stored on the computer readable storage media, for adding the branch instruction to a current segment in a trace in response to the result following the prediction, wherein the current segment includes an identification of a set of branch instructions in which each result for each branch instruction in the current segment follows a corresponding prediction for the each branch instruction;
program code, stored on the computer readable storage media, for adding the branch instruction to the current segment in the trace in response to an absence of the result following the prediction; and
program code, stored on the computer readable storage media, for creating a first new segment in the trace in which the first new segment includes a first branch instruction reached in the instructions from following the prediction and a second new segment in the trace in which the second new segment includes a second branch instruction in the instructions reached from not following the prediction in response to an absence of the result following the prediction.

18. The computer program product of claim 17 further comprising:
program code, stored on the computer readable storage media, for identifying which new branch instruction is reached from the result of the branch instruction to form an identified branch instruction, wherein the new branch instruction is selected from one of the first new branch instruction and the second new branch instruction; and
program code, stored on the computer readable storage media, for setting a particular segment from one of the first new segment and the second new segment that contains the identified branch instruction as the current segment.

19. The computer program product of claim 18 further comprising:
program code, stored on the computer readable storage media, for returning to the program code, stored on the computer readable, storage media, for processing the instructions after setting the particular segment.

20. The computer program product of claim 17 further comprising:
program code, stored on the computer readable storage media, for repeating the determining and adding steps while subsequent results for subsequent branch instructions follow predictions for the subsequent branch instructions.

21. The computer program product of claim 17 comprising:
program code, stored on the computer readable storage media, for determining whether a particular result generated from processing a selected branch instruction in a segment in the trace follows a particular prediction for the selected branch instruction in the segment in response to processing the instructions at a subsequent time; and
program code, stored on the computer readable storage media, for changing the segment to end after the selected branch instruction in response to an absence of the particular result following the particular prediction for the selected branch instruction.

22. The computer program product of claim 17, wherein the adding step comprises:
program code, stored on the computer readable storage media, for incrementing a counter for the segment.
